(19) United States
(12) Patent Application Publication
(10) Pub. No.: US 2024/0179609 A1
(43) Pub. Date: May 30, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/431,673

(22) Filed: Feb. 2, 2024

Related U.S. Application Data
(63) Continuation of application No. PCT/JP2022/029548, filed on Aug. 1, 2022.

(30) Foreign Application Priority Data
Aug. 3, 2021 (JP) 2021-127856

(51) Int. Cl. H04W 40/22; H04W 40/24; H04W 40/34

(52) U.S. Cl. CPC H04W 40/22; H04W 40/248; H04W 40/34

(57) ABSTRACT

In a first aspect, a communication control method is used in a cellular communication system. The communication control method includes: transmitting, by a relay node to a donor node, information indicating a Backhaul Adaptation Protocol (BAP) header rewriting function is supported; performing, by the donor node, configuration related to inter-topology routing for the relay node; and forwarding, by the relay node, a data packet in accordance with the configuration related to the inter-topology routing.

### RELATED APPLICATIONS

The present application is a continuation based on PCT Application No. PCT/JP2022/029548, filed on Aug. 1, 2022, which claims the benefit of Japanese Patent Application No. 2021-127856 filed on Aug. 3, 2021. The content of which is incorporated by reference herein in their entirety.

### TECHNICAL FIELD

The present invention relates to a communication control method used in a cellular communication system.

### BACKGROUND OF INVENTION

The Third Generation Partnership Project (3GPP), which is a standardization project of a cellular communication system, has been studying introduction of a new relay node referred to as an Integrated Access and Backhaul (IAB) node. One or more relay nodes are involved in communication between a base station and a user equipment and perform relay for the communication.

### CITATION LIST

### Non-Patent Literature

Non-Patent Document 1: 3GPP TS 38.300 V16.6.0 (2021-06)

### SUMMARY

In a first aspect, a communication control method is used in a cellular communication system. The communication control method includes: transmitting, by a relay node to a donor node, information indicating a Backhaul Adaptation Protocol (BAP) header rewriting function is supported; performing, by the donor node, configuration related to inter-topology routing for the relay node; and forwarding, by the relay node, a data packet in accordance with the configuration related to the inter-topology routing.

In a second aspect, a communication control method is used in a cellular communication system. The communication control method includes configuring, by a donor node, an alternative Routing ID associated with a routing ID for a relay node. The communication control method includes determining, by the relay node, to execute local rerouting for forwarding a data packet to an alternative path. The communication control method includes receiving, by the relay node, a data packet from another relay node. The communication control method includes executing, by the relay node, the local rerouting using another routing ID including a destination address matching a destination address included in the data packet, when the relay node cannot use the alternative routing ID.

In a third aspect, a communication control method is used in a cellular communication system. The communication control method includes configuring, by a donor node, a plurality of alternative routing IDs for a relay node. The communication control method includes determining, by the relay node, to execute local rerouting for forwarding a data packet to an alternative path. The communication control method includes receiving, by the relay node, a data packet from another relay node. The communication control method includes executing, by the relay node, the local rerouting using one of the plurality of alternative routing IDs.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of a user equipment (UE) according to an embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an example of inter-topology routing according to a first embodiment.

FIG. 10 is a diagram illustrating an operation example according to the first embodiment.

FIG. 11 is a diagram illustrating an operation example according to a second embodiment.

FIG. 12 is a diagram illustrating an operation example according to a third embodiment.

FIG. 13 is a diagram illustrating a relationship example between IAB nodes according to a fourth embodiment.

FIG. 14 is a diagram illustrating an operation example according to the fourth embodiment.

### DESCRIPTION OF EMBODIMENTS

The present disclosure has an object to provide a communication control method in which packet forwarding control is appropriately performed.

A cellular communication system in an embodiment will be described with reference to the drawings. In the description of the drawings, the same or similar parts are denoted by the same or similar reference signs.

### Configuration of Cellular Communication System

A configuration example of the cellular communication system according to an embodiment will be described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

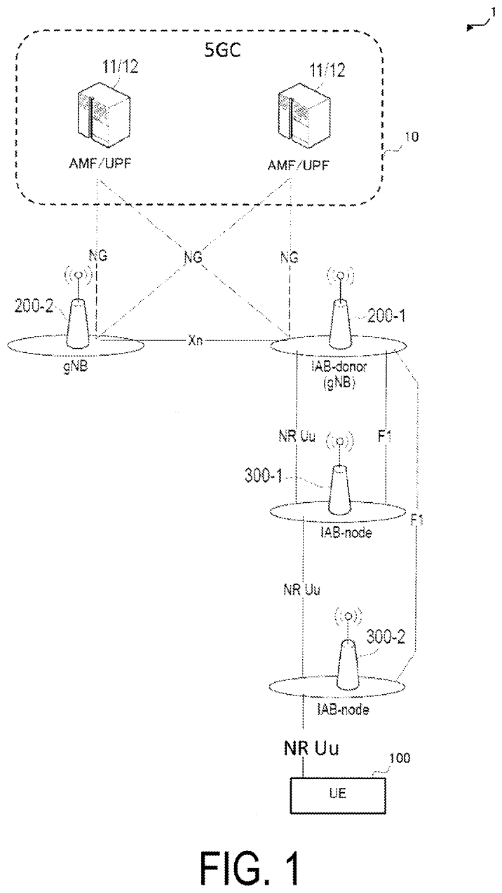

FIG. 1 is a diagram illustrating a configuration example of the cellular communication system 1 according to an embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a gNB.

An example in which the base station 200 is an NR base station will be mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which may be hereinafter referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

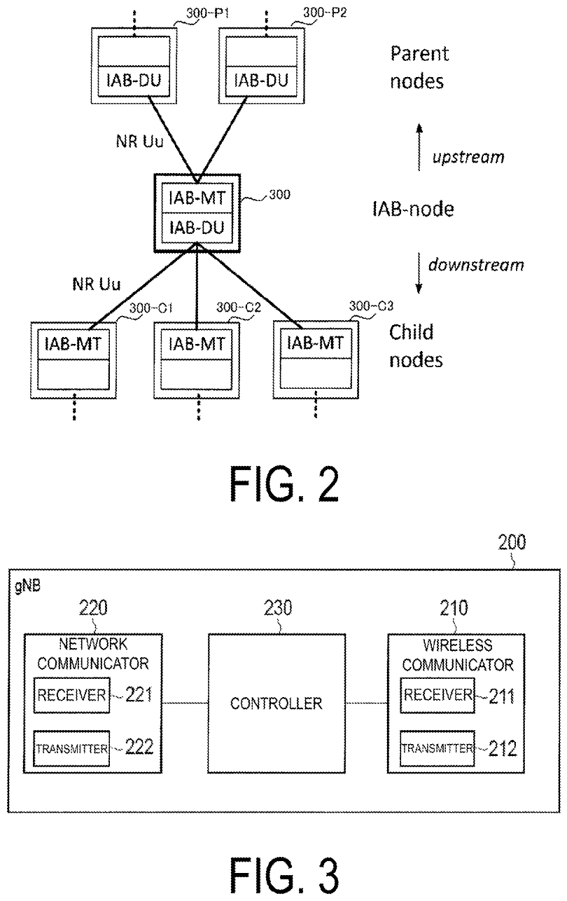

FIG. 2 is a diagram illustrating a relationship example between an IAB node 300, parent nodes, and child nodes.

As illustrated in FIG. 2, each IAB node 300 includes an IAB-DU corresponding to a base station functional unit and an IAB-Mobile Termination (MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream. Configuration of Base Station A configuration of the gNB 200 that is a base station according to the embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then transmitted to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 230 may perform each process or each operation in the gNB 200 in each embodiment.

### Configuration of Relay Node

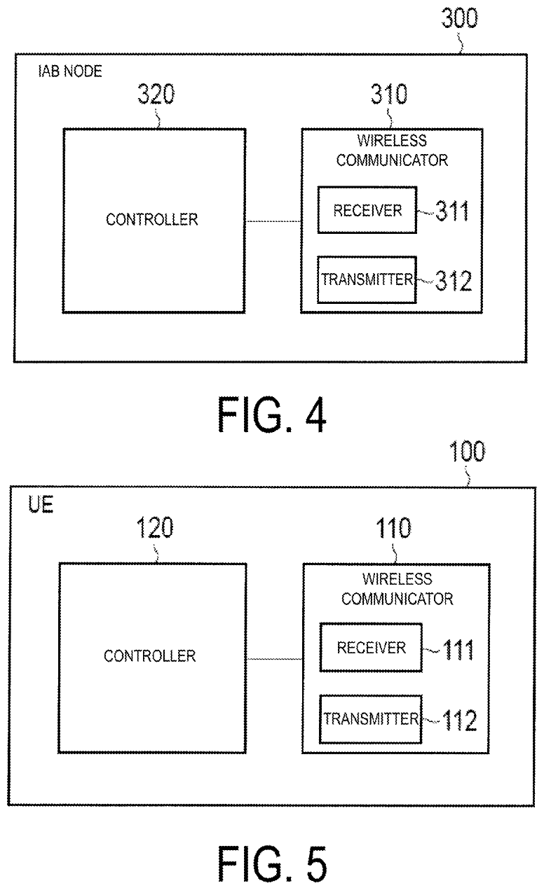

A configuration of the IAB node 300 that is a relay node (or a relay node apparatus, which may be hereinafter referred to as a “relay node”) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then transmitted to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 320 may perform each process or each operation in the IAB node 300 in each embodiment.

### Configuration of User Equipment

A configuration of the UE 100 that is a user equipment according to the embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then transmitted to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 130 may perform each process in the UE 100 in each embodiment described below.

### Configuration of Protocol Stack

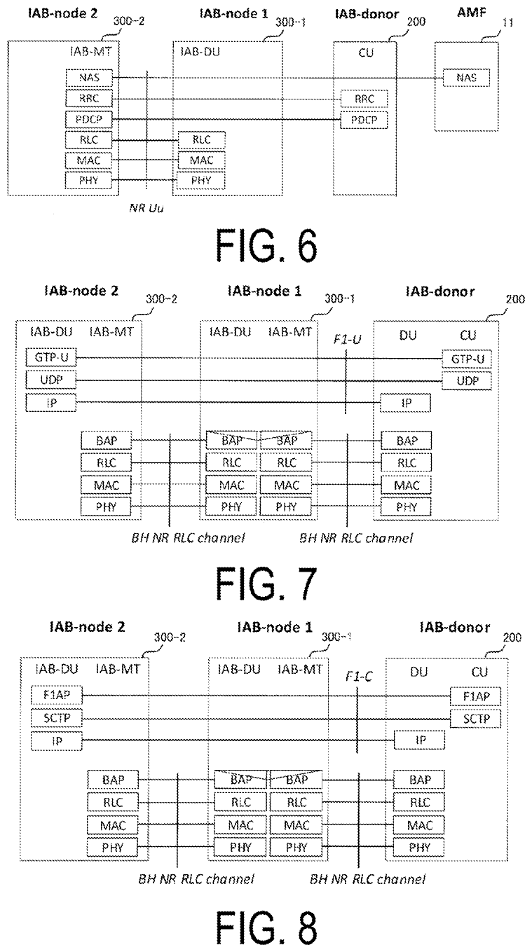

A configuration of a protocol stack according to the embodiment will be described. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs preferential control of data, retransmission processing using a hybrid ARQ (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines the transport format (transport block size, modulation and coding scheme (MCS)) and the assignment of resource blocks in the uplink and the downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the AMF 11.

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as a higher layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring each BH link to include a plurality of backhaul RLC channels enables the prioritization and QoS control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

First, routing, local rerouting, and inter-topology routing in the first embodiment will be described.

### Routing

Routing in the IAB node 300 will be described.

One of the functions of the BAP layer is to route packets to the next hop. In a network including a plurality of IAB nodes 300, each IAB node 300 forwards a received packet to the next hop, and can thereby eventually transmit the packet to the destination IAB node 300 (or the donor node 200). The routing is, for example, to control which IAB node 300 the received packet is forwarded to.

Packet routing is performed, for example, as follows. In other words, the IAB-CU of the donor node 200 provides a routing configuration to an IAB-DU of each IAB node 300. The provided routing configuration includes a routing ID and the BAP address of the next hop. The routing ID includes a destination BAP address (Destination) and a Path ID. When each IAB node 300 receives a packet (BAP packet), the IAB node 300 extracts the routing ID included in a header of the packet, and acquires the destination BAP address from the extracted routing ID. Each IAB node 300 determines whether the destination BAP address matches its own BAP address. Each IAB node 300 determines that the data packet has reached the destination when the destination BAP address matches its own BAP address. On the other hand, each IAB node 300 forwards the packet to an IAB node 300 having the BAP address of the next hop in accordance with the routing configuration when the destination BAP address does not match its own BAP address.

As described above, each IAB node 300 forwards the received BAP packet to the next hop in accordance with the routing configuration configured by the donor node 200, and transmits the BAP packet to the destination BAP address.

### Local Rerouting

Local rerouting will be described.

In a network including a plurality of IAB nodes 300, a Backhaul Radio Link Failure (BH RLF) may occur in a backhaul link between the IAB nodes 300. The BH RLF is one of line failures.

In a multi-hop network where packets are forwarded by a plurality of IAB nodes 300 one after another, data packets may be forwarded to a destination IAB node 300 (or donor node 200) via an alternative path. Even when a line failure occurs, a path in which the line failure occurs can be avoided and a data packet can be transmitted to the destination IAB node, on the condition that there is an alternative path to the same destination IAB node 300. Forwarding a data packet using an alternative path may be referred to as local rerouting. The local rerouting may be performed by selecting an alternative path, while ignoring the routing configuration configured by the donor node 200. Alternatively, the local rerouting may be performed by selecting an alternative path from alternative path candidates configured by the donor node 200.

The IAB node 300 performs local rerouting as follows, for example. That is, the IAB node 300 receives a data packet (BAP packet) from another IAB node. The IAB node 300 extracts the routing ID from a BAP header of the received BAP packet. The IAB node 300 extracts the destination BAP address (Destination) from the routing ID. The IAB node 300 selects another routing ID including the same BAP address as the destination BAP address. Such another routing ID is configured for the IAB node 300 in advance by the donor node 200. The IAB node 300 transmits (forwards) the received BAP packet to the destination BAP, using such another selected routing ID.

The local rerouting when the donor node 200 configures an alternative path is performed as follows, for example. That is, the donor node 200 configures the routing ID of the alternative path used in the local rerouting for the IAB node 300. The IAB node 300 extracts the routing ID from the BAP packet to be subjected to the local rerouting, and selects the routing ID of the alternative path corresponding to the extracted routing ID. The IAB node 300 forwards the packet, using the selected routing ID of the alternative path.

The routing ID of the alternative path configured for the local rerouting by the donor node 200 is hereinafter referred to as an alternative Routing ID. The alternative routing ID also includes the destination BAP address and the path ID, in a manner the same as and/or similar to the routing ID.

The IAB node 300 configured with the alternative routing ID can execute the local rerouting, using the alternative routing ID corresponding to the routing ID, without checking the destination BAP address included in the routing ID of the BAP packet. Thus, in the IAB node 300, delay can be reduced, and processing can be reduced.

### Inter-Topology Routing

Inter-topology routing will be described.

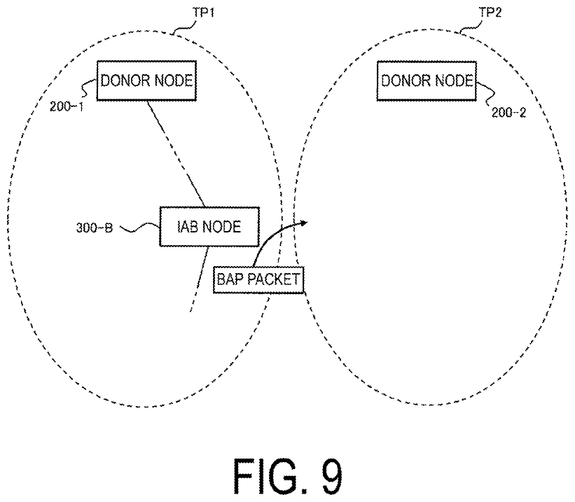

FIG. 9 is a diagram illustrating an example of inter-topology routing according to the first embodiment.

All of the IAB nodes 300 connected to the donor node 200 via one or more hops form a Directed Acyclic Graph (DAG) topology (which may be referred to as a “topology” below) rooted at the donor node 200. One topology includes one donor node 200. FIG. 9 illustrates an example in which a topology TP1 rooted at the donor node 200-1 and a topology TP2 rooted at the donor node 200-2 are formed.

For example, it is assumed that an RLF occurs in the IAB node 300 in the topology TP1. In this case, forwarding a packet to a destination node in another topology TP2 avoiding a path in which the RLF occurs may lead to faster recovery of a service. For the sake of load balancing between the topology TP1 and the topology TP2, for example, forwarding the packet occurring in the topology TP1 via the topology TP2 may lower a communication load of the topology TP1.

Thus, packet forwarding control may be performed using inter-topology routing. The inter-topology routing is to perform control of forwarding a packet from one topology TP1 to another topology TP2.

As described above, the BAP header of the BAP packet (BAP PDU) includes the routing ID. The routing ID is basically configured by the donor node 200. Thus, the routing ID is used in the topology of the donor node 200.

When the inter-topology routing is performed, the topology (or the donor node 200) is changed. Thus, the routing ID is changed. In other words, the destination BAP address (Destination) and the path ID are changed due to the inter-topology routing.

In the IAB node 300, by rewriting the routing ID included in the BAP header of the BAP packet to a changed routing ID, the routing ID can be changed. Rewriting of the routing ID included in the BAP header to the changed routing ID may be referred to as BAP Header rewriting. The IAB node 300 has a BAP header rewriting function, and can thus rewrite the routing ID.

The BAP header rewriting may be performed by the IAB node 300 located at a boundary with another topology. The IAB node 300 located at a boundary with a topology may be referred to as a boundary IAB node. FIG. 9 illustrates an example in which an IAB node 300-B has the BAP header rewriting function as the boundary IAB node. FIG. 9 illustrates an example in which the IAB node 300-B transmits (forwards) a BAP packet with its routing ID rewritten with the BAP header rewriting function to a destination node in another topology TP2.

Note that the BAP header rewriting may also be performed in the local rerouting. That is, in the local rerouting, a routing ID different from a routing ID included in a target BAP packet is used. Thus, when the IAB node 300 performs the local rerouting, the IAB node 300 can perform the BAP header rewriting and forward the BAP packet including a changed routing ID.

### Communication Control Method According to First Embodiment

When the inter-topology routing is performed, the donor node 200-1 needs to perform configuration related to the inter-topology routing for the IAB node 300-B in the topology TP1.

However, when the IAB node 300-B for which the configuration is performed does not have the BAP header rewriting function, the donor node 200-1 may not be able to efficiently perform the configuration related to the inter-topology routing for the IAB node 300-B.

In view of this, in the first embodiment, the IAB node 300-B transmits information indicating whether the IAB node 300-B has the BAP header rewriting function to the donor node 200-1.

Specifically, firstly, the relay node (for example, the IAB node 300-B) transmits information indicating support of the BAP header rewriting function to the donor node (for example, the donor node 200-1). Secondly, the donor node performs predetermined configuration for the relay node. Thirdly, the relay node forwards the data packet in accordance with the predetermined configuration. Here, the predetermined configuration is configuration related to the inter-topology routing for forwarding the data packet between topologies and/or configuration related to the local rerouting for forwarding the data packet to an alternative path.

As described above, the donor node 200-1 can receive the information indicating support of the BAP header rewriting function from the IAB node 300-B. Thus, the donor node 200-1 can efficiently perform the configuration related to the inter-topology routing and/or the configuration related to the local rerouting for the IAB node 300-B. Accordingly, packet forwarding control can be efficiently performed.

### Operation Example According to First Embodiment

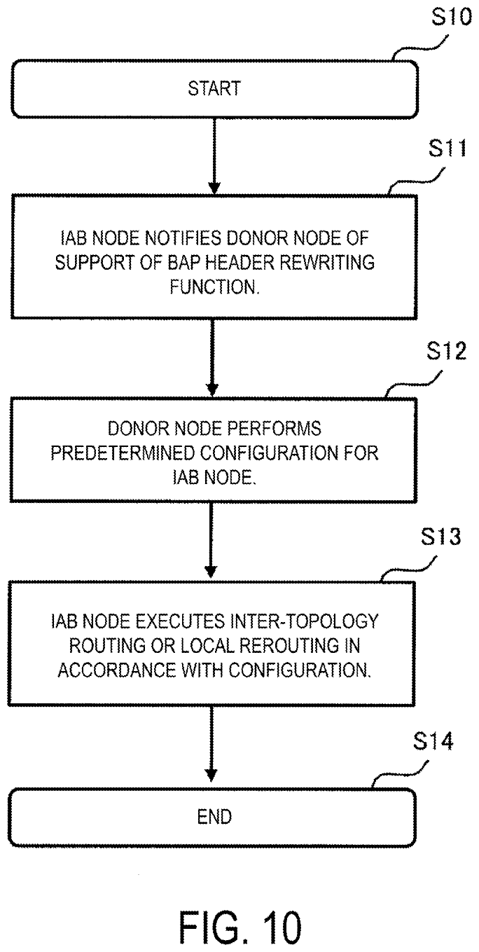

FIG. 10 is a diagram illustrating an operation example according to the first embodiment.

As illustrated in FIG. 10, in Step S10, the IAB node 300-B starts processing.

In Step S11, the IAB node 300-B transmits information indicating support of the BAP header rewriting function to the donor node 200-1. The IAB node 300-B may transmit information indicating whether the IAB node 300-B supports the BAP header rewriting function to the donor node 200-1.

Note that the IAB-MT of the IAB node 300-B may include the information in an RRC message, such as a UE Capability Information message or a UE Assistance Information message, and thereby transmit the information to the CU of the donor node 200-1. Alternatively, the IAB-DU of the IAB node 300-B may transmit an F1AP message including the information to the CU of the donor node 200-1.

In Step S12, when the donor node 200-1 receives the information, the donor node 200-1 performs predetermined configuration for the IAB node 300-B. Here, the predetermined configuration is (A1) configuration related to inter-topology routing and/or (A2) configuration related to local rerouting.

### (A1) The Configuration Related to the Inter-Topology Routing is as Follows, for Example.

That is, firstly, the donor node 200-1 configures, for the IAB node 300-B, Dual Connectivity (DC) in which the donor node 200-1 is a master node and the donor node 200-2 in another topology TP2 is a secondary node. Thus, the IAB node 300-B can directly connect to the donor node 200-2, and may thereby be a boundary IAB node located at a boundary with the topology TP1. The IAB node 300-B can also secure an alternative path.

Secondly, the donor node 200-1 performs configuration of an inter-topology routing table for the IAB node 300-1. The inter-topology routing table may include a routing ID in its own topology TP1 and a routing ID in another topology TP2 corresponding to the routing ID. Alternatively, the inter-topology routing table may include a routing ID in another topology TP2 without including a routing ID in its own topology TP1. In the IAB node 300-B, the routing ID of another topology TP2 can be acquired using the routing table, and the BAP header rewriting function can be executed.

### (A2) The Configuration Related to the Local Rerouting is as Follows, for Example.

That is, firstly, the donor node 200-1 may perform DC configuration for the IAB node 300-B. The DC configuration may be DC configuration between the donor node 200-1 and the IAB node in the topology TP1. Alternatively, the DC configuration may be DC configuration between the IAB node in its own topology TP1 and the IAB node (or the donor node 200-2) in another topology TP2. In either case, the donor node 200-1 can configure an alternative path for the local rerouting owing to the DC configuration.

Secondly, the donor node 200-1 configures an alternative routing ID for the IAB node 300-B. In this case, for each routing ID, the donor node 200-1 configures an alternative routing ID associated with the routing ID. Thus, the IAB node 300-B can execute the local rerouting for the BAP packet to be subjected to the local rerouting, using the alternative routing ID corresponding to the routing ID extracted from the BAP packet.

In Step S13, the IAB node 300-B executes the inter-topology routing and/or the local rerouting in accordance with the predetermined configuration. The IAB node 300-B rewrites the routing ID included in the BAP header of the BAP packet to be subjected to the inter-topology routing, based on the inter-topology routing table. Then, the IAB node 300-B transmits the rewritten BAP packet to the donor node 200-2. The IAB node 300-B rewrites the routing ID included in the BAP header of the BAP packet to be subjected to the local rerouting to the alternative routing ID. Then, the IAB node 300-B transmits the rewritten BAP packet, using the alternative path.

Then, in Step S14, the IAB node 300-B ends the series of processing.

### Second Embodiment

A second embodiment will be described.

As described above, in the operation of the local rerouting, operation may be performed in which the IAB node 300 extracts the routing ID from the BAP header and selects another routing ID with the same destination BAP address (Destination) as that included in the routing ID.

As described above, in the operation of the local rerouting, the IAB node 300 may perform operation using an alternative routing ID configured by the donor node 200.

At present, in 3GPP, the latter case has been under study. Regarding the operation of the local rerouting, the former operation may be referred to as “Rel-16 operation” and the latter operation as “Rel-17 operation”.

The second embodiment is an embodiment in which the IAB node 300-B performs the local rerouting according to the Rel-17 operation, but when an alternative routing ID is unavailable, the IAB node 300-B falls back to the Rel-16 operation.

Specifically, firstly, the donor node (for example, the donor node 200) configures an alternative routing ID associated with the routing ID for the relay node (for example, the IAB node 300). Secondly, the relay node determines to execute the local rerouting for forwarding a data packet to an alternative path. Thirdly, the relay node receives the data packet from another relay node. Fourthly, when the relay node cannot use the alternative routing ID, the relay node executes the local rerouting, using another routing ID including a destination address matching a destination address included in the data packet.

Thus, even when the IAB node 300 cannot use the alternative routing ID, the IAB node 300 can execute the local rerouting by performing the Rel-16 operation. Accordingly, packet forwarding control can be efficiently performed.

### Operation Example According to Second Embodiment

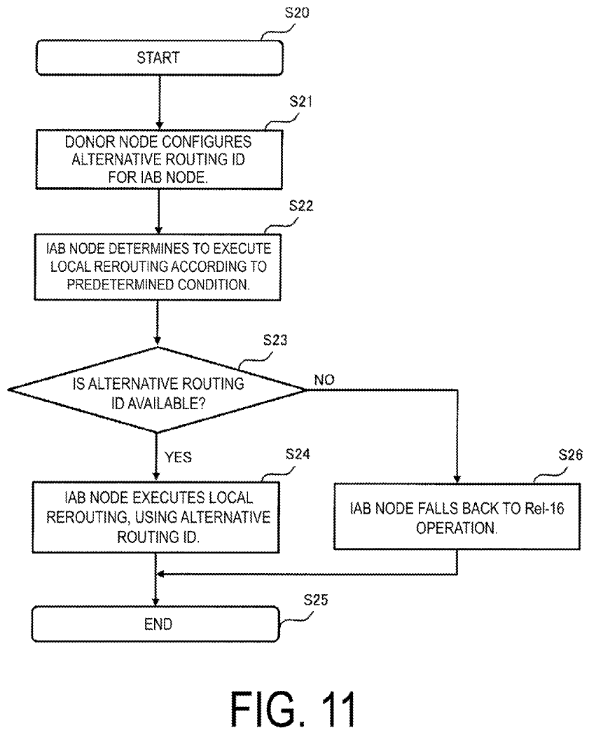

FIG. 11 is a diagram illustrating an operation example according to the second embodiment.

As illustrated in FIG. 11, in Step S20, the donor node 200 starts processing.

In Step S21, the donor node 200 configures an alternative routing ID for the IAB node 300. The donor node 200 configures the alternative routing ID associated with (or corresponding to) the routing ID to be subjected to the local rerouting. The donor node 200 configures the alternative routing ID for each routing ID to be subjected to the local rerouting.

Note that the CU of the donor node 200 may transmit an F1AP message including information related to the configuration to the IAB-DU of the IAB node 300, and thereby perform the configuration. Alternatively, the CU of the donor node 200 may transmit an RRC message including the information related to the configuration to the IAB-MT of the IAB node 300, and thereby perform the configuration.

In Step S22, when the IAB node 300 detects a predetermined condition, the IAB node 300 determines to execute the local rerouting. The predetermined condition includes an upstream predetermined condition and a downstream predetermined condition in the IAB node 300.

The upstream predetermined condition is one of detection of a BH RLF, reception of Type4 BH RLF Indication, reception of Type2 BH RLF Indication, and reception of UL flow control feedback.

The BH RLF is one of line failures detected by the IAB-MT of the IAB node 300 in the backhaul link. The Type4 BH RLF Indication is a notification about a failure, which indicates a failure in recovery of a BH RLF. The Type2 BH RLF Indication is a notification about occurrence of a failure, which indicates that recovery from a BH RLF is being attempted. The UL flow control feedback is flow control feedback to be introduced into Rel-17, and is flow control feedback transmitted by the IAB node 300 to its child node.

On the other hand, the downstream predetermined condition is one of reception of DL flow control feedback and some communication error.

The DL flow control feedback is flow control feedback transmitted by the IAB-MT of the IAB node 300 to a parent node of the IAB node 300 when, for example, a buffer load of the IAB node 300 exceeds a certain threshold.

When the IAB node 300 detects one of such predetermined conditions, the IAB node 300 determines to execute the local rerouting.

In Step S23, the IAB node 300 determines whether the alternative routing ID configured by the donor node 200 is available. For example, when there is a route (or a path, or a link) in which neither of the predetermined conditions in Step S22 is detected, the IAB node 300 may determine that the alternative routing ID corresponding to the route is available.

Alternatively, when there is an alternative route configured from the donor node 200, the IAB node 300 may determine that the alternative routing ID corresponding to the route is available.

When at least one of the predetermined conditions in Step S22 is detected in (a part or all of) such alternative routes configured from the donor node 200, the IAB node 300 may determine that the alternative routing ID corresponding to the route is unavailable.

When no alternative route is configured from the donor node 200, the IAB node 300 may determine that the alternative routing ID corresponding to the route is unavailable.

When the IAB node 300 determines that the alternative routing ID is available in Step S23 (YES in Step S23), the processing transitions to Step S24. On the other hand, when the IAB node 300 determines that the alternative routing ID is unavailable in Step S23 (NO in Step S23), the processing transitions to Step S26.

In Step S24, the IAB node 300 executes the local rerouting, using the alternative routing ID. For example, when the IAB node 300 receives a BAP packet (BAP PDU) including the routing ID to be subjected to the local rerouting from another IAB node, the IAB node 300 forwards the BAP packet, using the alternative routing ID associated with the routing ID. The destination BAP address included in the alternative routing ID has the same destination BAP address as that included in the routing ID and has a different path ID. Thus, the IAB node 300 may transmit the BAP packet to a path corresponding to the path ID included in the alternative routing ID. Note that the IAB node 300 may execute the BAP header rewriting described in the first embodiment. Specifically, because the destination BAP addresses are the same, the path ID is rewritten to a path ID of the alternative routing ID.

Then, in Step S25, the IAB node 300 ends the series of processing.

On the other hand, in Step S26, the IAB node 300 falls back to the Rel-16 operation. That is, because the alternative routing ID configured by the donor node 200 is unavailable, the IAB node 300 extracts the routing ID from the BAP packet (BAP PDU) to be subjected to the local rerouting, and selects another routing ID matching the destination BAP address included in the routing ID. Then, the IAB node 300 transmits the BAP packet, using such another selected routing ID.

Note that, in Step S26, the IAB node 300 need not execute the BAP header rewriting, unlike Step S24. In other words, the routing ID in the header of the BAP packet to be transmitted is different from the routing ID to be transmitted. Specifically, the destination BAP addresses are the same, but the path IDs are different.

Then, in Step S25, the IAB node 300 ends the series of processing.

### Third Embodiment

A third embodiment will be described.

The second embodiment describes an example in which the IAB node 300 determines whether the alternative routing ID is available, and when the alternative routing ID is unavailable, the IAB node 300 performs the Rel-16 operation.

For example, when the donor node 200 can configure a plurality of alternative routing IDs for the IAB node 300 in advance, a probability of performing the local rerouting using an alternative routing ID (that is, performing the Rel-17 operation) can be enhanced in the IAB node 300.

In view of this, in the third embodiment, the donor node 200 configures a plurality of alternative routing IDs for the IAB node 300.

Specifically, firstly, the donor node (for example, the donor node 200) configures a plurality of alternative routing IDs for the relay node (for example, the IAB node 300). Secondly, the relay node determines to execute the local rerouting for forwarding a data packet to an alternative path. Thirdly, the relay node receives the data packet from another relay node. Fourthly, the relay node executes the local rerouting, using one of the plurality of alternative routing IDs.

Thus, for example, because the plurality of alternative routing IDs are configured, a probability of performing the Rel-17 operation can be enhanced, and packet forwarding control can be efficiently performed.

### Operation Example According to Third Embodiment

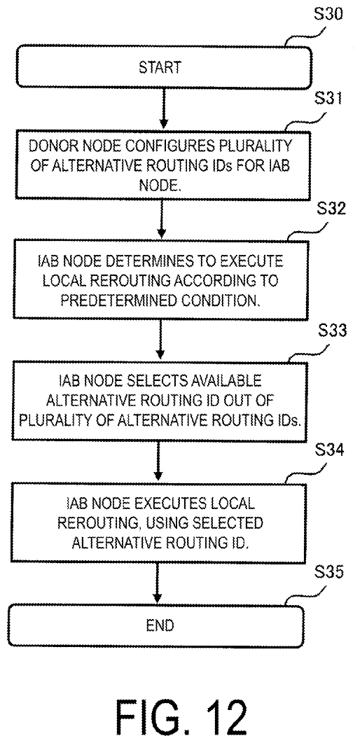

FIG. 12 is a diagram illustrating an operation example according to the third embodiment. As illustrated in FIG. 12, in Step S30, the donor node 200 starts processing.

In Step S31, the donor node 200 configures a plurality of alternative routing IDs for the IAB node 300. The plurality of alternative routing IDs may be configured in a form of a list. Order of entries of the plurality of alternative routing IDs in the form of a list may correspond to use priority. The alternative routing IDs may be added to (or compiled in) a list in descending order of use priority. The CU of the donor node 200 may perform configuration using an RRC message, an F1AP message, or the like, in a manner the same as and/or similar to the second embodiment (Step S21 of FIG. 11).

In Step S32, when the IAB node 300 that has received the configuration detects a predetermined condition, the IAB node 300 determines to execute the local rerouting. The predetermined conditions are the same as and/or similar to those of the second embodiment (Step S22 of FIG. 11).

In Step S33, the IAB node 300 selects an available alternative routing ID out of the plurality of alternative routing IDs. For example, the IAB node 300 determines availability regarding each of the plurality of alternative routing IDs, and selects an available alternative routing ID. When the plurality of alternative routing IDs are indicated in a form of a list, the IAB node 300 may sequentially determine availability from an alternative routing ID indicated as a first entry, and select an alternative routing ID that is first determined as being available as the available alternative routing ID. Availability may be determined in a manner the same as and/or similar to the second embodiment (Step S23 of FIG. 11).

Note that, when the IAB node 300 determines that all of the plurality of alternative routing IDs are unavailable, the IAB node 300 may fall back to the Rel-16 operation, in a manner the same as and/or similar to the second embodiment (Step S26 of FIG. 11).

In Step S34, when the IAB node 300 receives a BAP packet (BAP PDU) to be subjected to the local rerouting from another IAB node, the IAB node 300 executes the local rerouting, using the selected alternative routing ID. The local rerouting itself using the alternative routing ID may be the same as and/or similar to the second embodiment (Step S24 of FIG. 11).

Then, in Step S35, the IAB node 300 ends the series of processing.

### Fourth Embodiment

A fourth embodiment will be described.

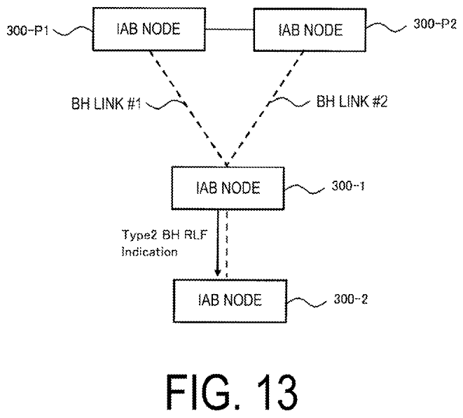

FIG. 13 is a diagram illustrating a relationship example between the IAB nodes according to the fourth embodiment.

As illustrated in FIG. 13, DC is configured for the IAB node 300-1. For example, the IAB node 300-P1 is a master node. The IAB node 300-P2 is a secondary node. In this case, the IAB node (master node) 300-P1 manages a master cell group (MCG). The IAB node (secondary node) 300-P2 manages a secondary cell group (SCG). The IAB node 300-P1 and the IAB node 300-P2 are parent nodes of the IAB node 300-1.

It is assumed that a BH RLF occurs in one of BH link #1 between the IAB node 300-1 and the IAB node 300-P1 and BH link #2 between the IAB node 300-1 and the IAB node 300-P2. The BH RLF occurring in BH link #1 may be referred to as an “MCG BH RLF”. The BH RLF occurring in BH link #2 may be referred to as an “SCG BH RLF”.

In such a situation, the fourth embodiment assumes the following two scenarios. That is, a first scenario is configuration of an alternative routing ID for the IAB node 300-1 when the IAB node 300-1 detects one of the MCG BH RLF and the SCG BH RLF. A second scenario is configuration of an alternative routing ID for the IAB node 300-2 when one of the MCG BH RLF and the SCG BH RLF is detected in the IAB node 300-1 being a parent node.

The fourth embodiment is an embodiment in which the donor node 200 configures an alternative routing ID of each cell group. Specifically, the donor node (for example, the donor node 200) configures an alternative routing ID of each cell group for the relay node (for example, the IAB node 300-1 or the IAB node 300-2).

Thus, for example, the donor node 200 can configure different alternative routing IDs for the IAB node 300-1 and the IAB node 300-2. Accordingly, the donor node 200 can configure the alternative routing IDs with the first scenario and the second scenario being taken into consideration.

For example, the donor node 200 can configure different alternative routing IDs for the local rerouting for the MCG BH RLF and the local rerouting for the SCG BH RLF. Accordingly, the IAB node 300-1 can execute the local rerouting depending on each of the MCG BH RLF and the SCG BH RLF, and can thereby appropriately forward a received packet.

### Operation Example According to Fourth Embodiment

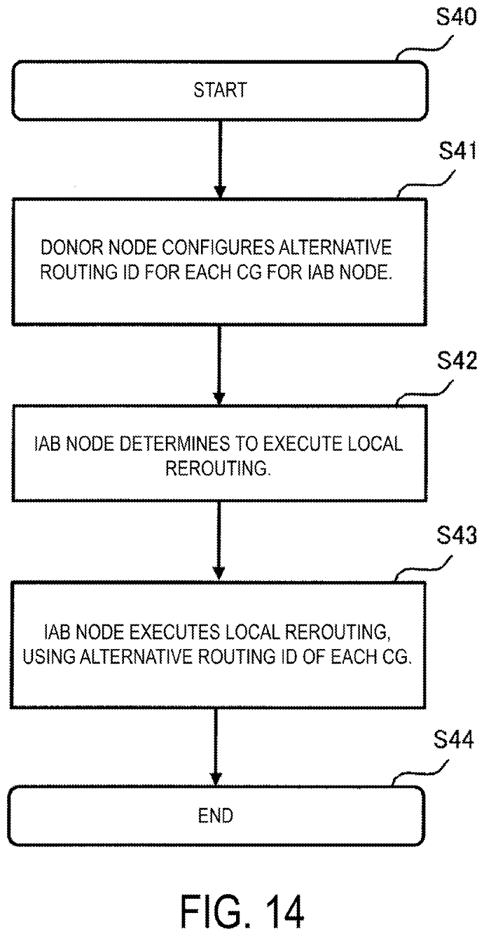

FIG. 14 is a diagram illustrating an operation example according to the fourth embodiment. As illustrated in FIG. 14, in Step S40, the donor node 200 starts processing.

In Step S41, the donor node 200 configures an alternative routing ID for each cell group (CG) for the IAB node 300. For example, the donor node 200 configures a first alternative routing ID for the MCG BH RLF, and configures a second alternative routing ID for the SCG BH RLF.

The configuration of the alternative routing ID of each CG may include information indicating whether the donor node 200 (B1) performs the configuration for the IAB node 300-1 or (B2) performs the configuration for the IAB node 300-2. The donor node 200 may further configure the following information in the case of (B1) and the case of (B2).

### (B1) Case of Configuration for IAB Node 300-1

When the donor node 200 performs the configuration for the IAB node 300-1, this means that the IAB node 300-1 itself detects a BH RLF. This corresponds to the first scenario. The donor node 200 may configure the first alternative routing ID for the MCG BH RLF, and configure the second alternative routing ID for the SCG BH RLF.

### (B2) Case of Configuration for IAB Node 300-2

On the other hand, when the donor node 200 performs the configuration for the IAB node 300-2, this means that the IAB node 300-2 receives Type2 BH RLF Indication from the IAB node 300-1 (for example, FIG. 13). This corresponds to the second scenario. The donor node 200 may configure a third alternative routing ID for the MCG BH RLF in the parent node 300-1, and configure a fourth alternative routing ID for the SCG BH RLF in the parent node 300-1. In this case, the third alternative routing ID is an alternative routing ID to be applied to the IAB node 300-2 being a child node of the parent node 300-1, when the MCG BH RLF occurs in the parent node 300-1. The fourth alternative routing ID is an alternative routing ID to be applied to the IAB node 300-2 being a child node of the parent node 300-1, when the SCG BH RLF occurs in the parent node 300-1.

With (B1) and (B2) being taken into consideration, the IAB node 300 may configure the first alternative routing ID and the second alternative routing ID for the first scenario (for its own detection of the BH RLF), and configure the third alternative routing ID and the fourth alternative routing ID for the second scenario (the parent node 300-1 detects the BH RLF).

In Step S42, the IAB node 300-1 or the IAB node 300-2 determines to execute the local rerouting. When the IAB node 300-1 detects one of the MCG BH RLF and the SCG BH RLF, the IAB node 300-1 determines to execute the local rerouting. When the IAB node 300-2 receives Type2 BH RLF Indication from the parent node 300-1, the IAB node 300-2 determines to execute the local rerouting. Note that the Type2 BH RLF Indication may include information indicating whether the BH RLF (MCG BH RLF) has occurred on the MCG side or the BH RLF (SCG BH RLF) has occurred on the SCG side in the IAB node 300-1 being a parent node. Alternatively, the information may be transmitted together with the Type2 BH RLF Indication.

In Step S43, when the IAB node 300-1 or the IAB node 300-2 receives a BAP packet (BAP PDU) to be subjected to the local rerouting, the IAB node 300-1 or the IAB node 300-2 executes the local rerouting for the BAP packet, using the alternative routing ID of each CG.

For example, when the IAB node 300-1 detects the MCG BH RLF, the IAB node 300-1 executes the local rerouting, using the first alternative routing ID.

For example, when the IAB node 300-1 detects the SCG BH RLF, the IAB node 300-1 executes the local rerouting, using the second alternative routing ID.

For example, when the IAB node 300-2 receives information indicating that the MCG BH RLF has occurred in the IAB node 300-1 together with the Type2 Indication from the IAB node 300-1 being a parent node, the IAB node 300-2 executes the local rerouting, using the third alternative routing ID.

For example, when the IAB node 300-2 receives information indicating that the SCG BH RLF has occurred in the IAB node 300-1 together with the Type2 Indication from the IAB node 300-1 being a parent node, the IAB node 300-2 executes the local rerouting, using the fourth alternative routing ID.

The operation of the local rerouting itself using the alternative routing ID may be the same as and/or similar to the second embodiment (Step S24 of FIG. 11).

Then, in Step S44, the IAB node 300-1 or the IAB node 300-2 ends the series of processing.

### OTHER EMBODIMENTS

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on”, unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1: Mobile communication system
10: 5GC
100: UE
110: Wireless communicator
120: Controller
200 (200-1 to 200-3): gNB (donor node)
210: Wireless communicator
220: Network communicator
230: Controller
300 (300-1, 300-2, 300-P1, 300-P2): IAB node
310: Wireless communicator
320: Controller

1. A communication control method used in a cellular communication system, the communication control method comprising:
transmitting, by a relay node, to a donor node information indicating that a Backhaul Adaptation Protocol (BAP) header rewriting function is supported.

2. The communication control method according to claim 1, further comprising:
forwarding, by the relay node, a data packet in accordance with configuration related to inter topology routing, wherein
the relay node is located at a boundary between a first topology and a second topology, and
the configuration includes information indicating that a routing ID of the second topology is adapted and a routing ID of the first topology not adapted.

3. The communication control method according to claim 1, wherein
the forwarding includes rewriting, by the relay node, a routing ID included in the data packet from the routing ID related to the first topology to the routing ID related to the second topology.

4. A communication control method used in a cellular communication system, the communication control method comprising:
receiving, by a donor node, from a relay node information indicating that a Backhaul Adaptation Protocol (BAP) header rewriting function is supported; and
performing, by the donor node, configuration related to inter topology routing to the relay node, wherein
the relay node is located at a boundary between a first topology and a second topology, and
the configuration includes information indicating that a routing ID of the second topology is adapted and a routing ID of the first topology not adapted.

5. A relay node in a cellular communication system, the node comprising a transceiver circuitry and a processing circuitry operatively associated with the transceiver circuitry and configured to execute processing of:
transmitting to a donor node information indicating that a Backhaul Adaptation Protocol (BAP) header rewriting function is supported.

6. A donor node in cellular communication system, the node comprising a receiver circuitry and a processing circuitry operatively associated with the receiver circuitry and configured to execute processing of:
receiving from a relay node information indicating that a Backhaul Adaptation Protocol (BAP) header rewriting function is supported; and
performing configuration related to inter topology routing to the relay node, wherein
the relay node is located at a boundary between a first topology and a second topology, and
the configuration includes information indicating that a routing ID of the second topology is adapted and a routing ID of the first topology not adapted.

7. A cellular communication system comprising:
a relay node; and
a donor node, wherein
the relay node transmits to a donor node information indicating that a Backhaul Adaptation Protocol (BAP) header rewriting function is supported.

8. A cellular communication system comprising:
a relay node; and
a donor node, wherein
the donor node receives from a relay node information indicating that a Backhaul Adaptation Protocol (BAP) header rewriting function is supported,
the nonor node performs configuration related to inter topology routing to the relay node,
the relay node is located at a boundary between a first topology and a second topology, and
the configuration includes information indicating that a routing ID of the second topology is adapted and a routing ID of the first topology not adapted.

9. A non-transitory computer-readable storage medium storing a program for causing a computer in a relay node to execute processing comprising:
transmitting to a donor node information indicating that a Backhaul Adaptation Protocol (BAP) header rewriting function is supported.

10. A non-transitory computer-readable storage medium storing a program for causing a computer in a donor node to execute processing comprising:
receiving from a relay node information indicating that a Backhaul Adaptation Protocol (BAP) header rewriting function is supported; and
performing configuration related to inter topology routing to the relay node, wherein
the relay node is located at a boundary between a first topology and a second topology, and
the configuration includes information indicating that a routing ID of the second topology is adapted and a routing ID of the first topology not adapted.

11. A chipset for a relay node in a cellular communication system, the chipset comprising:
transmitting to a donor node information indicating that a Backhaul Adaptation Protocol (BAP) header rewriting function is supported.

12. A chipset for a donor node in a cellular communication system, the chipset comprising:
receiving from a relay node information indicating that a Backhaul Adaptation Protocol (BAP) header rewriting function is supported; and
performing configuration related to inter topology routing to the relay node, wherein
the relay node is located at a boundary between a first topology and a second topology, and
the configuration includes information indicating that a routing ID of the second topology is adapted and a routing ID of the first topology not adapted.
